(19) United States
(12) Patent Application Publication
(10) Pub. No.: US 2026/0216914 A1
(43) Pub. Date: Jul. 30, 2026

(54) A CONCRETE 3D PRINTING APPARATUS

(71) Applicant: Kelvin6k Technologies Private Limited, Chennai (IN)

(72) Inventors: Pradeepkumar Sundarraj, Chennai (IN); Ravi Kant Upadhyay, Chennai (IN); Harish G S, Chennai (IN)

(21) Appl. No.: 19/147,726

(22) PCT Filed: Jan. 13, 2024
(86) PCT No.: PCT/IN2024/050035

§ 371 Date: Jul. 14, 2025

(30) Foreign Application Priority Data
Jan. 13, 2023 (IN) 202341002889
Dec. 18, 2023 (IN) 202341086380

(51) Int. Cl. B28B 1/00; B33Y 30/00; E04G 21/04

(52) U.S. Cl. CPC B28B 1/001; B33Y 30/00; E04G 21/0418

(57) ABSTRACT

A concrete 3D printing apparatus, for constructing buildings and structures, comprises a primary manoeuvring arm, a secondary manoeuvring arm, a support base and a linear translator setup. The primary and secondary manoeuvring arms are adapted to move rotationally along the horizontal plane. The distal end of the secondary manoeuvring arm is movably attached to a frame of linear translator through a mounting plate. The holding provision is attached to bottom of the frame of the linear translator. The linear translation mechanism of the linear translator is partially coupled to the mounting plate by mechanical means. The frame of the linear translator is actuated to move along the vertical plane to span the vertical range of the print head movement. Stabilisation mechanisms and load balancing provided for the stable movement of linear translator and the gravity load on the manoeuvring arms both at rest and during operation.

### REFERENCE TO RELATED APPLICATION

The application is the U.S. national-stage entry under 35 U.S.C. 371 of International Application No. PCT/IN2024/050035, filed on 13 Jan. 2024, and claims priority to Indian Patent Application number 202341002889, titled “A CONCRETE 3D PRINTING APPARATUS”, filed on 13 Jan. 2023, and Indian Patent Application number 202341086380, titled “A COMPACT CONCRETE 3D PRINTER WITH IMPROVED STABILITY”, filed on 18 Dec. 2023, the disclosures of which are incorporated herein by reference.”

### FIELD

The present subject matter relates to the field of automated building construction. In particular, the present subject matter relates to 3D printing for constructing concrete-based structures.

### BACKGROUND

The construction industry is labour intensive employing long established techniques of building structures of brick and mortar. While construction materials have evolved over the years with significant improvements in their properties, construction techniques have witnessed only minimal changes. The time and labour required makes the construction process an expensive proposition.

Pre-fabricated structures which are built as modular units and assembled together on-site have been a popular solution to save the time required to build a structure. However, transporting such structures is not easy and the choice of architectural designs with pre-built structures is limited.

The quest for on-site building with faster construction and limited labour resource has led to the development of automated processes. For instance, CN108908928A discloses a large-scale 3D printer that uses hot melt cement, comprising vertical support and vertical movement device, including vertical pillars, rotating platform and perpendicular drive component; Horizontally-supported cantilever and polar diameter telecontrol equipment, including horizontally-supported cantilever and polar diameter driving assembly. The movement of the horizontally supported cantilever beam is through the movement of the rotating platform. This is very energy consuming and not an agile operation.

Alternatively, US20160361834A discloses a 3D printer having an extendable boom arm with an extruder for extruding a concrete-based chemical solution and moves with translational and rotational motion in an XOY plane. The extendable boom arm is mounted such that it is capable of height adjustment in a XOZ plane. However, here again the rotation mechanism is on the base with a truss mounted on the rotation mechanism for connecting a height adjustment for up and down movement. The mechanism involved moves considerable weight from the base and hence is not energy efficient or agile. An important aspect of designing the 3D printers is ensuring stable operation with the working load. Further, a highly stable structure can print accurately but may lag in the time taken to move and print. Hence a sufficiently stable agile printer is desirable

Hence, in spite of the considerable improvement made to automate the building process, there is a requirement to develop an apparatus with functional yet simple structure with weight conscious design, that is capable of agile movements. The objective of the work is to design a 3D printing apparatus, for building concrete structures, with manoeuvrability in all directions, stability features to ensure risk free operation, agility.

### SUMMARY

The present subject matter is a concrete 3D printing apparatus for constructing buildings and structures. The concrete 3D printing apparatus comprises a primary manoeuvring arm, a secondary manoeuvring arm, a support base and a holding provision. The primary manoeuvring arm is adapted to move rotationally along the horizontal plane. The support base is connected to a first end of the primary manoeuvring arm. A first drive mechanism actuates the movement of the primary manoeuvring arm. The secondary manoeuvring arm is adapted to move rotationally along the horizontal plane and is attached to the second end of the primary manoeuvring arm. A second drive mechanism actuates the movement of the secondary manoeuvring arm. The holding provision at a distal end of the secondary manoeuvring arm is adapted to support a construction tool. The construction tool in the case of 3D concrete printing is a print head connected to a hose.

The distal end of the secondary manoeuvring arm is attached to a linear translation mechanism partially coupled to the mounting plate by mechanical means. The frame of the linear translator is actuated to move along the vertical plane to span the vertical range of movement of the holding provision. The linear translation mechanism is anyone of a chain and sprocket, rack and pinion, and lead screw depending on the requirement of speed and efficiency. A truss element is provided on the primary manoeuvring arm to balance the load on the primary manoeuvring arm. In addition, a counter weight is provided at the first end of the primary manoeuvring arm. Hence, sufficient load balancing is provided for the gravity load on the manoeuvring arms both at rest and during operation. These features enable simple and agile movements of a print head. Stabilisation mechanisms and load balancing is provided for the stable movement of linear translator and the gravity load on the manoeuvring arms both at rest and during operation. These features enable stable and agile movements of a print head with faster printing.

### BRIEF DESCRIPTION OF THE FIGURES

These FIG. 1 illustrates a concrete 3D printing apparatus with support base as a tower, as an embodiment of the present subject matter.

FIG. 2 illustrates linear translator with a chain sprocket mechanism in (a) front view, and (b) a close-up view of the mounting plate fixed on the chain, as an embodiment of the present subject matter.

FIG. 3 illustrates a linear translator with a rack and pinion mechanism in (a) front view, and (b) a close up view of the mounting plate and the rack and pinion mechanism, as an embodiment of the present subject matter.

FIG. 4 illustrates (a) a nested frame of the linear translator, as an embodiment of the present subject matter; (b) illustrates the operation of the nested frames during printing.

FIG. 5 illustrates a stabilisation system of a cable and pulley mechanism, as an embodiment of the present subject matter.

FIG. 6 (a. b) illustrates a stabilisation system of a moving support shaft attached on the secondary arm, as an embodiment of the present subject matter.

FIG. 7 illustrates a stabilisation system consists of a two-pulley belt, as an embodiment of the present subject matter.

FIG. 8 illustrates a cable support set up to augment a light weight primary and secondary arm in a 3D printer, as an embodiment of the present subject matter.

FIG. 9 illustrates a profile view of a concrete 3D printing apparatus with (a) a light weight primary and secondary arm and (b) a truss tower and arm made of modular units, as an embodiment of the present subject matter.

FIG. 10 illustrates (a) the apparatus with a layered hydraulic system as the support base and (b) vertical movement of the manoeuvring arms using the layered hydraulic system, as an embodiment of the present subject matter.

FIG. 11 illustrates an example implementation to build a structure pattern, as an embodiment of the present subject matter.

FIG. 12 illustrates the progressive printing of concrete layers in a time span of 30 seconds with snapshots of progress every five seconds.

FIG. 13 illustrates the progressive construction of an angular wall as an example implementation.

FIG. 14 illustrates the progressive construction of a concrete structure as an example implementation.

Further, those skilled in the art will appreciate that elements in the figures are illustrated for simplicity and may not have necessarily been drawn to scale. Furthermore, the figures may show only those specific details that are pertinent to understanding the embodiments of the present invention so as not to obscure the figures with details that will be readily apparent to those skilled in the art having the benefit of the description herein.

### DETAILED DESCRIPTION OF EXAMPLE EMBODIMENTS

The present subject matter relates to a concrete 3D printing apparatus for constructing buildings and structures. The concrete 3D printing apparatus comprises: a primary manoeuvring arm adapted to move rotationally along the horizontal plane; a support base which is connected to a first end of the primary manoeuvring arm with a first drive mechanism in-between to actuate the movement of the primary manoeuvring arm; a secondary manoeuvring arm adapted to move rotationally along the horizontal plane and attached to the second end of the primary manoeuvring arm with a second drive mechanism in-between to actuate the movement of the secondary manoeuvring arm; and a holding provision at a distal end of the secondary manoeuvring arm, adapted to support a construction tool; wherein the construction tool is a print head connected to a hose for concrete 3D printing.

The distal end of the secondary manoeuvring arm is attached to a linear translator on which the holding provision is mounted for translation along the vertical plane. A truss element is provided on the primary manoeuvring arm to balance the load on the primary manoeuvring arm. In addition, a counter weight is provided at the first end of the primary manoeuvring arm. The above features enable simple and agile movements of a print head.

FIG. 1 illustrates a profile view of a concrete 3D printing apparatus, as an embodiment of the present subject matter. The concrete 3D printing apparatus comprises primary and secondary manoeuvring arms to reach the distal end of the secondary manoeuvring arm to the desired point of printing.

An elbow joint connecting primary (204) and secondary manoeuvring arm (202) allows the easy extension and folding of the manoeuvring arm. The proximal end of the primary manoeuvring arm is mounted on top of a support base which is a tower (216). At the connection of the primary manoeuvring arm and the base, a rotational slew drive mechanism (203) is installed. In an embodiment of the present subject matter, a slew drive with a gear ratio of 61 is combined with the planetary gearbox of 40 gear ratio, which is then connected to a servo motor. This combination will reduce the speed of the servo motor from the original speed of the servo motor but increase the torque of the system. This increased torque will make the system more powerful and able to perform heavy-duty tasks. The effective gear ratio of the slew drive mechanism is above 40. In an example implementation, the gear ratio between the gearbox output and the slew drive is 61:40, so the gear ratio of the whole system is 1:2440. This means that for every 2.4 Nm of torque from the servo motor, the gear box will provide 5856 Nm of force to the slew drive. This will enable the slew drive to provide smoother and more precise motion than is possible with a direct servo motor drive. This rotation slew drive mechanism (203) enables 360° horizontal movement of the manoeuvring arm. The concrete 3D printing set up comprises the concrete 3D printing apparatus (100), extrusion pump (101), hose pipe (102) and print head (201). The print head (201) is attached to the end of the hose pipe (102). The extrusion pump (101) pumps the concrete mixture through the hose pipe (102). The print head (201) is attachable to the concrete 3D printing apparatus (100) and acts as the exit point for the concrete mixture for printing as layers of concrete to form a building or structure. The concrete mixture could have varying composition. In an embodiment, the concrete mixture comprises cement, sand, gravel, and gypsum.

The distal end of the secondary manoeuvring arm is attached to a linear translator through the mounting plate enabling the linear translator to move along the vertical plane. The mounting plate is at the distal end of the secondary manoeuvring arm. The linear translator setup comprises a frame, a motor, a linear translation mechanism and a holding provision. The holding provision is attached to bottom of the frame of the linear translator. Two parallel rods of the frame are movably attached to the mounting plate. The linear translation mechanism is housed on the frame and is partially coupled to the mounting plate by mechanical means. The motor drives the linear translation mechanism whereby the frame is actuated to move along the vertical plane to span the vertical range of the concrete 3D printing apparatus. The stabilisation mechanisms and load balancing is provided for the stable movement of frame and supporting the gravity load on the manoeuvring arms both at rest and during operation. The linear translation mechanism is anyone of a chain and sprocket, rack and pinion, and lead screw depending on the requirement of speed and efficiency.

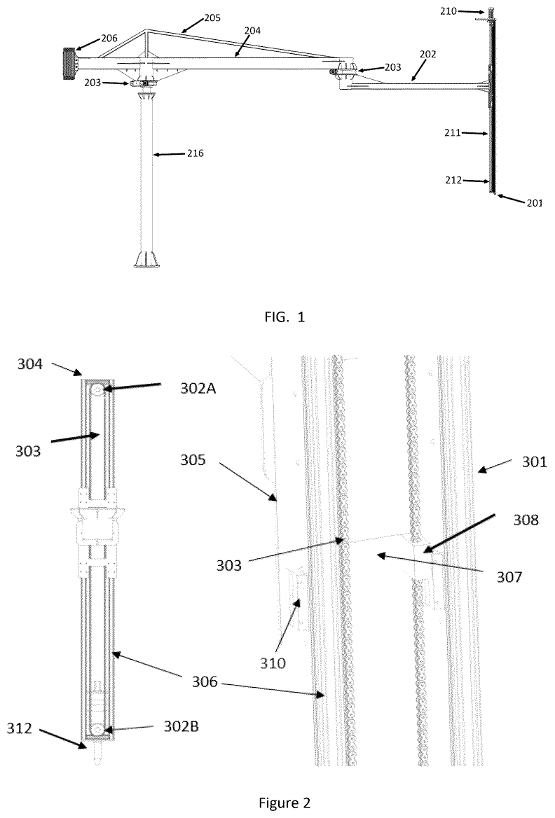

FIG. 2 illustrates a linear translator with a chain sprocket mechanism in (a) front view, and (b) a close up view of the mounting plate fixed on the chain, as an embodiment of the present subject matter. The chain and sprocket setup comprises a metal frame (301), a sprockets (302A), an idler (302B), a chain (303) and a motor (304). The metal frame comprises two parallel rods positioned along the length of the frame and connected at the top and bottom. At the other side of the metal frame (301), sprocket (302A) is attached at the top and the idler (302B) at the bottom with the chain (303) fixed on the spokes of the sprocket and idler forming a closed loop over the sprocket and idler. The sprocket (302A) is connected to a motor (304). The motor (304) enables the rotation of the top sprocket (302A) whereby the idler (302B) also rotates in tandem by the movement of the chain over the sprocket. Four linear bearing pillow blocks (310) are attached one at each corner of the mounting plate (305). The mounting plate (305) is connected to the two parallel rods of the metal frame (306) by mechanically engaging the parallel rods on the linear bearing pillow blocks. This engagement enables the metal frame (301) to freely move up and down. The mounting plate (305) further comprises a connecting plate (307) at the bottom with a chain holder (308) within which a segment of the chain (303) is held.

As the chain (303) moves due to the rotation of the sprocket (302A), the mounting plate, connected to the chain via chain holder, is subjected to translational force. However, as the mounting plate is fixed, the two parallel rods of the metal frame (306) moves up and down along the vertical axis, depending on the direction of rotation of the sprocket (302A).

The motor (304) operation can be configured to auto-operate the chain-sprocket mechanism. During concrete 3D printing, the height of the print head is varied by using the chain-sprocket setup and the range of height accessible for printing is determined by the range of height to which the chain-sprocket set-up will move upward.

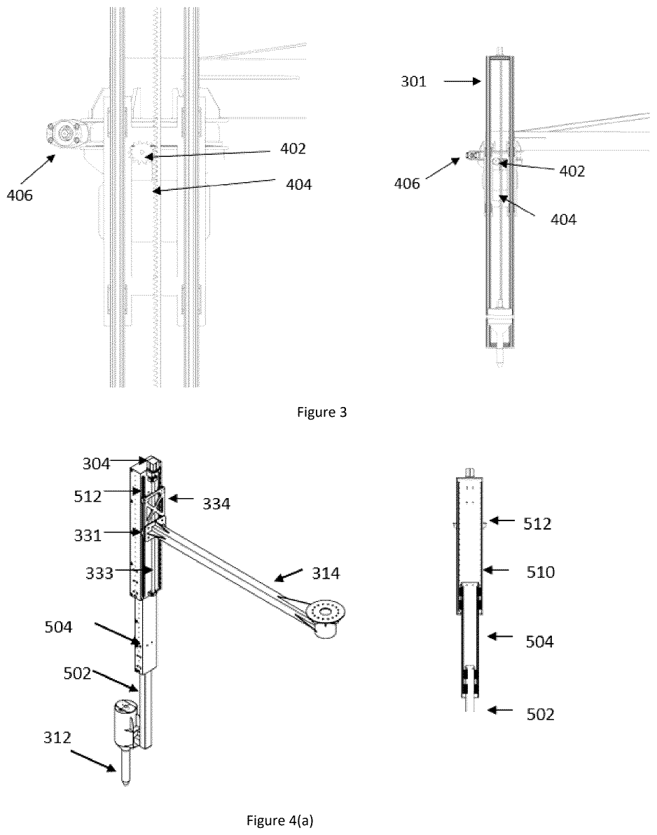

FIG. 3 illustrates a linear translator with a rack and pinion mechanism in (a) front view, and (b) a close-up view of the mounting plate and the rack and pinion mechanism, as an embodiment of the present subject matter. The Rack and pinion setup comprises a metal frame (301), a Pinion gear (402), a Rack gear (404) and motor (406). Four linear bearing pillow blocks (310) are attached at each corner of the mounting plate (305). With the help of linear bearing pillow blocks (310), the mounting plate (305) is connected to the two parallel rods attached to the sides of the metal frame (306). The bearing ensures that the two parallel rods are movable up and down relative to the mounting plate. The Rack gear (404) is engaged with the pinion gear (402) through teeth of Rack gear (404) meshing with the teeth of pinion gear (404). The pinion gear (404) is connected to a motor (406). The pinion gear (404) is also attached to the mounting plate. The motor (406) actuated the rotation of the pinion gear (404) which in turn moves the Rack gear (402) engaged with the pinion gear (404). Based on the rotation direction, the Rack gear (402) moves up and down along the vertical axis. The two parallel rods at the sides of the metal frame (306) move in sync enabling the movement of the holding provision attached at the bottom of the metal frame. The motor (406) controls the movement of the metal frame and can be programmed to auto-lift up or down relative to the mounting plate. During concrete 3D printing, the elevation of the print head is varied by using the Rack and pinion setup and the range of height accessible for printing is determined by the range of height to which the Rack moves upward.

The linear translator can be operated using a lead screw mechanism, wherein a similar set up is used. The lead screw setup comprises a metal frame, lifting motor, and a trapezoidal threaded rod. Four linear bearing pillow blocks are attached at each corner of the mounting plate. With the help of linear bearing pillow blocks, the mounting plate is connected to the two parallel rods attached to both sides of the metal frame. The bearing ensures that the parallel rods can freely move up and down relative to the fixed mounting plate. The trapezoidal threaded rod is also connected to the top and bottom connecting plates of the mounting plate by lead screw nuts. The trapezoidal threaded rod is connected to the lifting motor at the top. The motor rotates the trapezoidal threaded rod and based on the rotation direction, the parallel rods of the metal frame move up and down along the vertical axis. The lifting motor controls the movement of the metal frame and can be configured to auto-lift up or down, with the holding provision attached at the bottom of the metal frame. During 3D printing, the height of the print head is varied by using the leadscrew setup and the range of height accessible for printing is determined by the range of height to which the leadscrew setup will move upward.

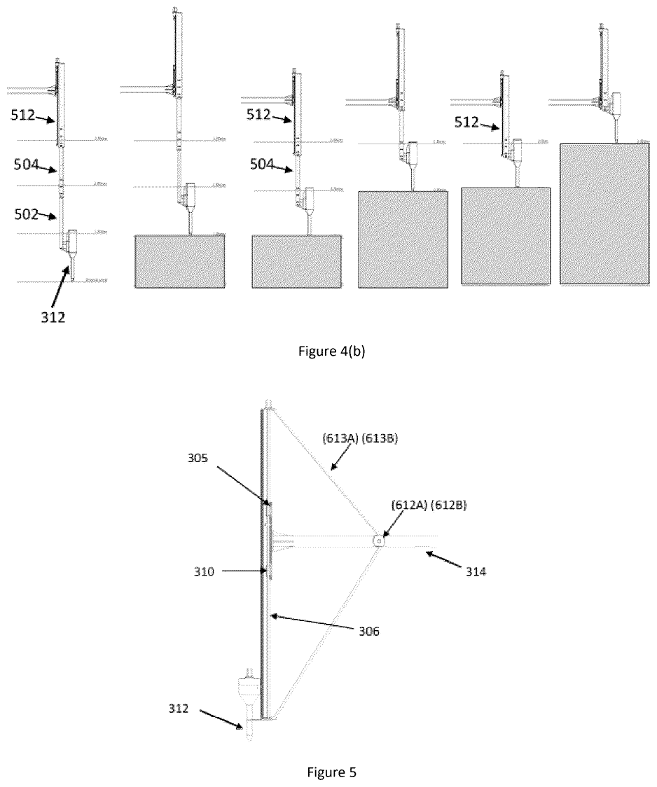

In another implementation of the present subject matter, the frame of the linear translator is designed as a nested frame. The nested frame comprises set of frames with decreasing width, wherein one set of frames is housed within the gap of the frame with higher width. The frames are configured to slide out to form an elongated structure. The first set of frames (512) is mechanically coupled to the mounting plate and translate along with the moving component of the translator mechanism. The other set of frames move independent of the translator mechanism. The maximum vertical span of the holding provision, to which the print head is attached, is the length of the frame in the fully extended configuration. Hence for the same vertical span, the nested frame translator can use a shorter translator mechanism which improves the stability and efficiency. FIG. 4(a) illustrates the nested frames in a linear translator attached to the secondary arm in a profile view and illustrates the nesting of frames in the fully extended configuration.

In an example configuration, three set of frames are used. The first set of frames (512) is coupled to the translator mechanism with a vertical span of 1 m. The second set of frames (504) is positioned in the inner space between the parallel rods of the first set of frames. A first guide rail (510) is provided on which the second set of frames (504) is slideably seated by a sliding provision (508) with a span of 1 m. The sliding action can be performed manually or by the control system. The third set of frames (502) is positioned in the inner space of the second set of frames (504). A second guide rail (507) is provided on which the third set of frames (502) is slideably seated by a sliding provision (506) with a span of 1 m. The sliding action can be performed manually or by the control system. FIG. 4(b) illustrates the operation of the nested frames during printing. Initially, all the frames are slid out in the fully open configuration. The printing starts from the ground level. For the first 1 m height, the linear translator moves up using the translating mechanism while the print head prints the concrete mix upto 1 m. Next, the third set of frames (502) is pushed up by sliding on the second guide rail to nest inside the second set of frames (504) and secured against moving. The first set of frames (512) is moved down using the linear translator, such that the print head is positioned at 1 m above the ground level. Printing is started and the first set of frames (512) is moved up using the linear translator as the print head prints from 1 m to 2 m height. Upon reaching the 2 m height, the second set of frames (504), with the third set of frames (502) nested inside, is pushed up into the interior space of the first set of frames. The first set of frames (512) is moved down using the linear translator, such that the print head is positioned at 2 m above the ground level. Printing is started and the first set of frames (512) is moved up using the linear translator as the print head prints from 2 m to 3 m height.

### Secondary Stabilisation Mechanism

The Z-axis movement of the holding provision using the linear actuator can be further stabilized with the help of a secondary stabilisation mechanism supported on the secondary arm. This secondary stabilisation mechanism, supported on the secondary arm, enables the direct transfer of the load on the printhead, fixed on the holding provision, to the secondary arm, thereby increasing the capacity of the printhead to carry more amount of the construction material in the hopper without causing any significant bend and vibration in the printhead during printing. In an implementation, approximately 50 Kg more concrete material was added to the hopper attached to the holding provision without affecting the stability of the printhead. Adding additional load of upto 150 Kg with a total load of 200 Kg also the printer operations were stable.

In an embodiment of the present subject matter, secondary stabilisation mechanism is a set of pulleys fixed on both sides of the secondary arm, with a set of tension cables running over the pulleys. The ends of the tension cables are attached to the top and bottom of the metal frame of the linear translator, respectively. As the metal frame moves up and down, the vertical movement of the printhead was stabilized by this arrangement of tension cables supported on the pulleys. FIG. 5 illustrates a side view of the linear translator with a stabilisation system of a cable and pulley mechanism, as an embodiment of the present subject matter. A set of pulleys (612A) (612B) are fixed on both side on the secondary arm. The tension cables (613A) (613B) each run over the pulleys (612A) (612B) respectively. The side view enables the visibility of one pulley and tension cable while the other pulley and tension cable is hidden in view. In FIG. 5, a profile view of the stabilisation mechanism is shown, where the placement of the pulleys (612A) (612B) and the tension cables (613A) (613B) connected to the top and bottom of the metal frame (301) of the linear translator is clearly seen. The tension in the cables is designed to enable stable motion of the frame of the linear translator, enabling smooth movement of the print head (312).

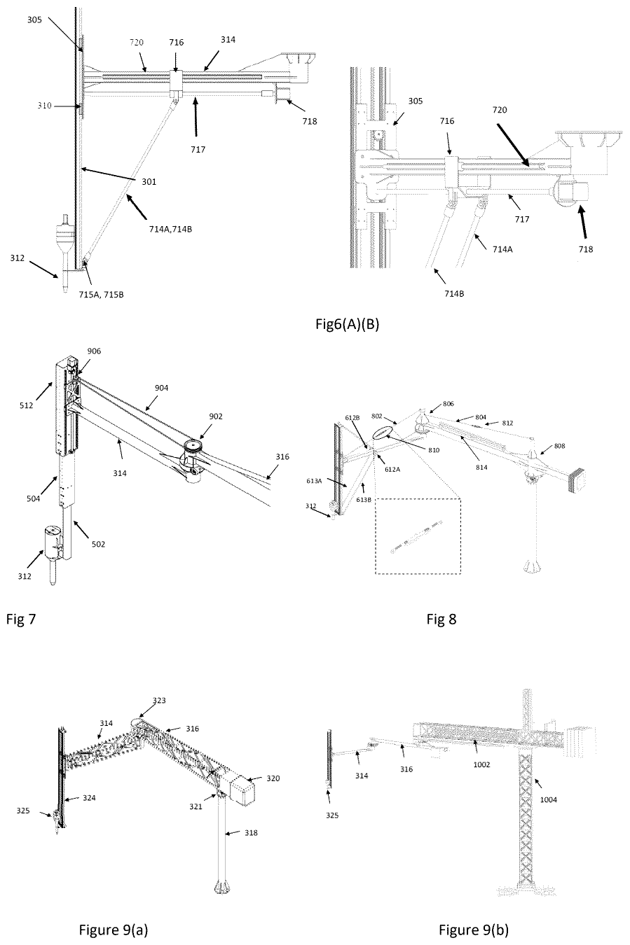

In another implementation, secondary stabilisation mechanism is a set of support shafts connected at one end to the bottom of the metal frame via pivot joints. The other end of the support shafts is connected to a movable frame configured to move along the secondary arm. As the metal frame moves up and down on the linear translator, the movable frame is moved in tandem outwards and inwards on the secondary arm such that the support shaft is held at various degree of slant to transfer the load from the mounting plate to the secondary arm. FIG. 6 illustrates a linear translator with a stabilisation system of a moving support shaft attached on the secondary arm in (a) side view and in (b) profile view, as an embodiment of the present subject matter. The secondary stabilisation mechanism is a set of support shafts (714A) (714B) connected at one end to the bottom of the metal frame (301) via pivot joints (715A) (715B). The other end of the support shafts (714A) (714B) is connected to a movable frame (716) supported on guiding rails attached to both side of the secondary arm (314). The movable frame (716) is fixed on a lead screw (717) connected to a motor (718) at the one end and to the mounting plate (305) at the other end. The movement of the lead screw (717) is controlled by a lead screw motor (718). The motor (304) of the linear translator actuating the movement of the metal frame (301) along the vertical direction is synchronized with the lead screw motor (718) actuating the lead screw (717) movement. So, when the motor (304) makes the metal frame (301) to move vertically upwards, the lead screw motor (718) drives the movable frame (716) to move away the mounting plate. Similarly, when the motor (304) makes the metal frame (301) to move downwards vertically then the lead crew motor (718) makes the movable frame (716) connected with support shaft (714A) (714B) move towards the mounting plate (305). This synchronized operation of the motor (304) and the lead screw motor (718) orients the support shaft (714A) (714B) at the suitable inclination to transfer the load on to the secondary arm. The set of support shaft (714A) (714B) make sure that the printhead (312) attached to the holding provision (325) at the bottom of the metal frame (301) is properly stabilized and free of any possible vibration during printing. In FIG. 5(b), a profile view of the stabilisation mechanism is shown in a close up view of the support shafts (714A) (714B) connected to the secondary arm (314). The movable frame (716) is slidably coupled on the guide rail (720) of the secondary arm (314), to enable movement of the movable frame (716) in sync with the linear translator. Further, the load transfer is also effected by the same arrangement.

The movement of the print head, supported on the holding provision, is thus made stable by using a linear translator for height adjustment and by supporting the load on the secondary arm.

In yet another implementation, the linear translator is provided with a stabilization means using cable or solid rods connecting the top end of the linear translator with the top end of the connection position of the primary and secondary arm. FIG. 7 illustrates a stabilisation system of a two-pulley belt, as an embodiment of the present subject matter. The first pulley (906) is attached to top end of the top end of the mounting plate on which linear translator is mounted and the second pulley (902) is attached at the top end of the connection position of the primary (316) and secondary arm (314). A belt (904) over the two pulleys provides the tensile support to stabilise the mounting plate and thus the linear translator. This type of stabilisation means is suitable in embodiments where only the top of the linear translator is accessible for connecting to a stabilization means through a connecting plate.

Further, during the synchronized movement of the primary and secondary arm any jerk in the movement can result in vibration during printing. To overcome this problem, a tension support mechanism is proposed. The tension support mechanism comprises two rotating units, tension cables, and turn buckles. The first rotating unit is positioned on the top of the connection position of the primary and secondary arms. The second rotating unit is positioned on top of the connection position of the primary arm with the support base. A first set of tension cables connect the distal end of the secondary arm and the first rotating unit with turn buckles in-between. A second set of tension cables connect the first rotating unit and the second rotating unit with turn buckles in-between. Theses tension cables with turn buckles acts as stabilization means and ensures less vibration during operation. It also acts as mechanical support to the arms.

FIG. 8 shows additional set up to stabilize primary and secondary arm. During the operation to stabilize the primary and secondary arm to avoid any potential vibration two cable (802) (804) were installed along with dual rotating mechanisms (806) (808) mounted respectively on the elbow joint (322) and on the far end of the primary arm (316). Both cables have turn buckles (810) (812) respectively to facilitate movement of the cables. The first cable (802) is connected to the mounting plate (305) at one end and to a first rotating mechanism (806) on the elbow joint (322) at the other end. The second cable (804) is connected to a second rotating mechanism (808) on the elbow joint (322) at one end and to the rotating mechanism (808) on the far end of the primary arm (318). A truss support (814) is also provided on the primary arm to further provide support to the arm. Overall, both the truss set up and the tension support mechanism enable vibration free movement of the primary and second arm during printing.

To reduce the weight of the machine the solid arms is replaced with arms having a truss structure. FIG. 9(a) illustrates a profile view of a concrete 3D printing apparatus with a light weight primary and secondary arm, as an embodiment of the present subject matter. The truss structure reduces nearly 30-40% of the overall weight of the 3D printing apparatus compared with that of solid arms. This reduction in weight makes the transportation of the arms cost-effective and convenient. Additionally, it also enables increasing the length of the arms up to 12 meters without requirement of any significant change in the machine design. As shown in FIG. 9(a), both arms can be made of truss structure that will reduce the overall weight of the arms significantly and will also reduce the work of the rotating motors. Additionally, the base support is designed as a truss structure to further reduce the weight of the 3D printer.

In another embodiment of the present subject matter, the primary and secondary manoeuvring arm set up is supported on an extended truss arm supported on a modular truss tower. FIG. 9(b) illustrates a profile view of a concrete 3D printing apparatus with a truss tower and arm made of modular units, as an embodiment of the present subject matter. The modular truss tower (1004) enables easy transport of the printer setup to a construction site and also varying the height of the truss tower (1004). The modular units are stacked one on top of the other and connected by securing means to form the truss tower (1004). The truss arm (1002) is attached at the top end of the truss tower (1004). The primary arm (316), at one end is secured to the distal end of the truss arm (1002), and with the secondary arm (314) rotationally connected to the other end of the primary arm (316).

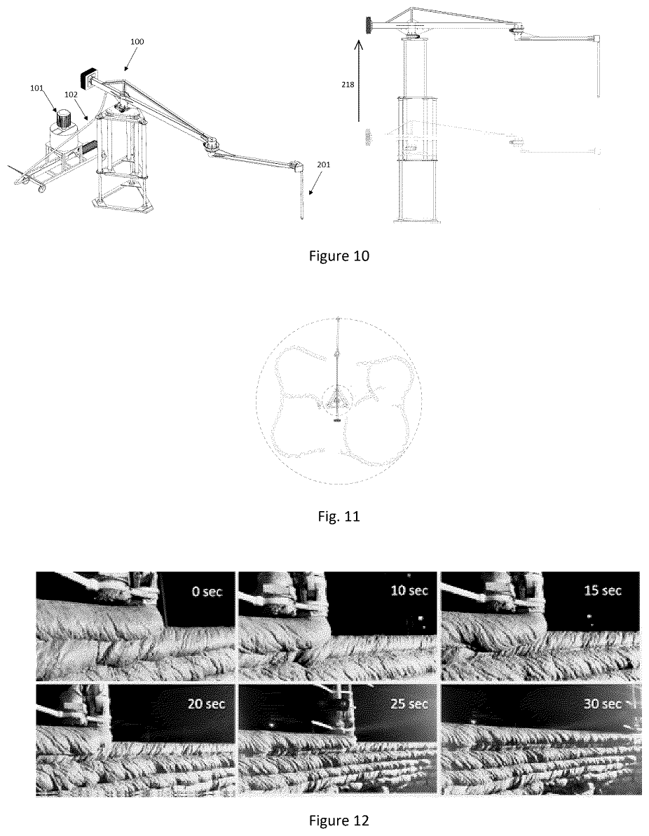

The horizontal span of the 3D printer is dependent on the lengths of the primary and secondary arms. Hence, additional arms are connected between the primary and secondary arms with the same degree of freedom to enable a wider span reach. FIG. 10 illustrates a profile view of a concrete 3D printing apparatus with three arms, connected in series, configured to independently span the horizontal plane, as an embodiment of the present subject matter. Apart from the primary (316) and secondary arm (314), an additional arm is provided as an intermediate arm (330). The intermediate arm (330) is connected to the primary and secondary arm at each end and the connection points are provided with a drive mechanism in-between for the rotational movement of the arms along the horizontal plane. Apart from providing an increased span, there is more agility in moving the print head along curved constructions.

In an example implementation, a 3D robotic printer comprises a primary and secondary arm of length 6 m and 6 m respectively, with a Warren truss structure. In order to provide stability a cable support system with turn buckles as described in FIG. 6 is used. The linear translator used with a chain-sprocket mechanism. The printing of a 5×3 ft wall was completed in 20 minutes showing the effectiveness of increased speed and stability due to the reduced weight and cable support along with the chain-sprocket mechanism.

In yet another example, a rack and gear mechanism was used in the linear translator of 3 m length along with a set of secondary shafts connected to a movable frame supported on the secondary arm as shown in FIG. 3. The transfer of load onto the secondary arm enabled smoother operation of the translator where a steady operation was observed inspite of the length of the linear translator thus enabling elimination of possibility of misalignment during printing of successive layers. The printed walls were observed to have successive layers with offset of less than +/−1 mm

Another example implementation used a three-stage linear translator as in FIG. 4 with a linear screw mechanism. This enabled use of longer arms and more stable operations as only a shorter linear screw was used for vertical translating. A two-pulley belt stabilization means was used. The printed wall layers were smoother with uniform width and height while also having negligible layer-wise offset. Further, given the compact linear translator, the load experienced by the arms and the rotating mechanisms is drastically reduced enabling a longer service life of the driving mechanisms of the system. Further, the likelihood of accidents during windy weather conditions were minimised due to the compactness. The time required for alignment during follow up printing on successive days was reduced by 50%.

A holding provision is attached to the bottom of the frame. The holding provision is configured to hold any construction tool. Primarily for 3D printing, a print head, attached to a pipe end to eject the concrete mixture for layering, is attached to the holding provision. Alternatively, for finishing the surface for a smooth appearance, a finishing tool is attached to the holding tool.

In an embodiment of the present subject matter, the support base is a hydraulic system serves both to vary the height and to support the load of the manoeuvring arms and the operational load of the extra weight when the print head of the hose carrying concrete is fixed on the holding provision. To balance these loads, the layered hydraulic system comprises a plurality of hydraulic cylinders which perform the dual function of providing support as well as lifting the primary manoeuvring arm.

The support base is a hydraulic system, resting on an outer triangular base. The hydraulic system is oriented vertically, and comprises at least two sets of hydraulic cylinders. Each set comprises a plurality of hydraulic cylinders. The vertical orientation of the hydraulic cylinders of one set is in the direction opposite to vertical orientation of the hydraulic cylinders of the other set. The actuating of the hydraulic system is performed by sequential actuation of each set. On full actuation, the pistons of each set are extended in opposite direction. The actuation of the hydraulic system varies the height of support base.

In an embodiment, as shown in FIG. 11(a), six hydraulic cylinders are provided, with three cylinders in the outer perimeter and the other three in the inner perimeter. Each of the hydraulic cylinder has an outer cylinder and a piston, with either of the outer cylinder or piston being fixed, the other will move on actuation. The three base hydraulic cylinders are positioned at the vertices of the outer triangular base. The outer cylinder of the three base hydraulic cylinders are movable with fixed piston. An inner triangular base is attached to the outer cylinder of the three base hydraulic cylinders. The three top hydraulic cylinders are positioned at the vertices of the inner triangular base. An inner triangular top is attached to the piston of the three top hydraulic cylinders, and an outer triangular top is attached to the top of the outer cylinder of the three base hydraulic cylinders. Moreover, the piston of the three top hydraulic cylinders are movable with fixed outer cylinder.

FIG. 11(b) illustrates the vertical movement of the manoeuvring arms using the hydraulic system, as an embodiment of the present subject matter. On actuation, the outer cylinders move and along with it the inner triangular base also moves, while the pistons of the three base hydraulic cylinders are attached to the outer triangular base. As the inner triangular base moves up, the three top hydraulic cylinders also move up. This forms a two tier support base, with the pistons of the three base hydraulic cylinders forming one tier, and the outer cylinders forming the second tier. When the top hydraulic cylinders are actuated, the pistons of the top hydraulic cylinders move up along with the inner triangular top. This forms a third layer in the support base and determines the maximum height. With complete actuation of the base hydraulic cylinders, a three tier support base is formed.

Since the inner triangular top is the only surface which raises to the top most level, the first drive mechanism is attached on the inner triangular top and to the first end of the primary manoeuvring arm. Hence the primary manoeuvring arm is supported on a tripod-like base (210) on the inner triangular top of a hydraulic system (208) that can lift the manoeuvring arm according to the required height along the vertical plane.

In an embodiment of the present subject matter, the counter weight structure is another set of manoeuvring arms positioned diagonally opposite to the primary manoeuvring arm. Further, the base of the 3D printing system can accommodate multiple manoeuvring arms, each of which is equipped with different nozzles, accessories, or tools that can perform a variety of functions. For example, one manoeuvring arm can be used to print a layer of building material while another manoeuvring arm with a plastering nozzle (216) can simultaneously finish the printed wall. Additionally, other manoeuvring arms may be used to attach a painting nozzle (217) for painting purposes and an attachment (215) for filling the foundation of the construction. This comprehensive and multifunctional 3D printing system can execute multiple tasks associated with construction, such as printing, reinforcement, finishing, painting, etc., thus minimizing the need for manual labor.

Example: In an example implementation of the present subject matter, a building structure with curved walls is built by the layering of concrete. The top view of the structure pattern is illustrated in FIG. 11. The top view of the 3D concrete layering is shown with the 3D concrete layering apparatus depicted. From a given position of the triangular support base, the outer dotted circle showing the maximum extension from the support base and the inner dotted circle showing the minimum distance from the support base reachable by the manoeuvring arms. All other areas between these two circles are reachable and hence with the apparatus stationed at the given position the entire structure can be built by 3D printing. The fully erected foldable manoeuvring arm can reach up to 6 meters; therefore, if placed at the center of a circle, then it can print at any point in the circular area of ~113 m2. However, the length of the manoeuvring arm and the number of elbow joints can further be increased up to 25 m to enhance the area of the work envelope. Similarly, the maximum height up to which the hydraulics can lift the printhead-mounted manoeuvring arm can also be increased by adding multiple hydraulics units or by placing the printer on a taller base. Additionally, the linear screw translator installed at the distal end of the secondary manoeuvering arm can also be modified for printing at higher lengths. In the example implementation shown in FIG. 10(b), the maximum height up to which the hydraulics can lift the manoeuvring arm is 3.6 meters, and the linear screw translator can raise the print head up to 3 meters so the printer can print up to a height of total 6.6 meters from the ground level.

The print head can be positioned at the desired coordinate using the controller, and moved according to a pre-defined printing path. Once one layer is deposited, the print head is lifted to a fixed height with the help of either the lifting mechanism installed at the support base (layered hydraulic system) or the leadscrew setup (the linear actuating mechanism), so the deposition of the next layer can be carried out on top of the first layer. The elbow-enabled synchronized motion of both the primary and secondary manoeuvring arms ensures that the nozzle can reach any coordinate within the work envelope of the foldable manoeuvring arm. The synchronized motion of both manoeuvring arms enables the printing of any desired shape of any dimension within the area of the work envelope. The progressive layering of concrete layers is depicted in FIG. 12.

### Example:

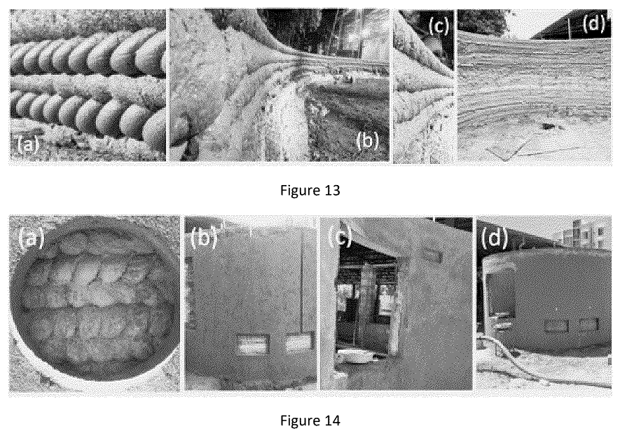

In an example implementation of the present subject matter, an arc shaped room is printed. The mixture containing cement, sand, fly ash, water and plasticizer is used as the layering mixture. The ratio of water to cement was maintained at nearly 0.4. All the components were mixed in a rotatory concrete mixture and the resulting paste was fed in to an extrusion pump which pumped the mixture through a pipe connecting pump and the nozzle mounted on the extended manoeuvring arm. The printing mixture extrudes from the nozzle and as a result of the synchronized motion of both manoeuvring arms the printing of layers in different shapes is achieved (FIG. 13 a-c). The flow rate of the printing mixture can be varied as required. Multiple layers were deposited to form the wall of the room. More than 50 layers were deposited to construct a wall of height of approximately 250 cm (FIG. 14d). The width of each of the layer was varied between 4-6 cm (FIG. 14a).

The arc shaped room had a diameter of nearly 188 cm. After depositing sufficient number of layers, finishing of the wall was carried out to give it a smooth finish (FIG. 14b-d). The compressive strength of the wall was measured by cutting a small piece from the wall and found to be in the acceptable range.

The concrete 3D printing apparatus has a provision to attach wheels at the bottom of the outer triangular base. Hence the structure can be transported easily to the construction site for onsite building construction. Moreover, the apparatus consists to modular units which can be separated into modular units. Hence the components of the 3D printing system can be assembled at the site also.

In an implementation of the present subject matter, the 3D printing system is a SCARA (Selective Compliance Assembly Robot Arm/Selective Compliance Articulated Robot Arm) model. A plurality of multiple manoeuvring arms coupled with printing heads can be provided in the apparatus to execute simultaneous printing at different areas in the work envelope. The manoeuvring arms can have single or multiple elbow joints that expand their reach even into confined spaces.

Moreover, the concrete 3D printing apparatus can be transported as modular units and assembled on-site. The control system of the concrete 3D printing apparatus is a compact unit, with the slew drive mechanisms, the lead screw setup, and the hydraulic mechanism being actuated by the control system.

In a preferred embodiment of the present subject matter, the concrete 3D printing apparatus for buildings and structures comprises: a primary manoeuvring arm adapted to move rotationally along the horizontal plane; a support base which is connected to a first end of the primary manoeuvring arm with a first drive mechanism in-between to actuate the movement of the primary manoeuvring arm; a secondary manoeuvring arm adapted to move rotationally along the horizontal plane and attached to the second end of the primary manoeuvring arm with a second drive mechanism in-between to actuate the movement of the secondary manoeuvring arm; and a linear translator at a distal end of the secondary manoeuvring arm, adapted to support a holding provision.

The support base is configured to support the weight of the concrete 3D printing apparatus, the linear translator setup comprises a frame, a motor, a linear translation mechanism. Two parallel rods of the frame are movably attached to the mounting plate; the linear translation mechanism is housed on the frame and is partially coupled to the mounting plate by mechanical means. A motor drives the linear translation mechanism whereby the frame is actuated to move along the vertical plane to span the vertical range of the concrete 3D printing apparatus. The linear translation mechanism is anyone of a chain and sprocket, rack and pinion, and lead screw setup. Stabilisation mechanisms and load balancing is provided for the stable movement of frame and supporting the gravity load on the manoeuvring arms both at rest and during operation.

The frame is a nested frame comprising a set of sub-frames with progressively decreasing width, nested within one another, wherein one sub-frame is slidably housed within the gap of the sub-frame with next higher width. The sub-frames are configured to slide out to form a longer structure. The holding provision is attached to the bottom of the innermost sub-frame with the least width. The outermost sub-frame is movably coupled to the mounting plate and is actuated to move vertically by the linear translation mechanism housed on it. Light weight primary and secondary arm have truss structure and the base support is a modular truss structure.

Further, the support base is mountable on a wheeled structure to enable movement of the construction apparatus.

With the demonstrated performance of the concrete 3D printing apparatus, the apparatus has potential application in the field of building and structures construction. The concrete 3D printing machine is capable of printing building structures with a high level of precision. Besides printing walls, the 3D printing machine can also execute post-construction treatments such as finishing and painting by switching the accessories at the printing head. The 3D printing machine is highly robust, stable and can run day and night continuously, regardless of weather conditions.

A person skilled in the art will appreciate that one or more of the elements may well be combined into a single functional element. Alternatively, certain elements may be split into multiple functional elements. Elements from one embodiment may be added to another. The order of the processes described herein may be changed and not limited to the manned described herein. Moreover, the actions of any flow diagram need not be implemented in the order shown. The scope of the embodiments is by no means limited by those specific examples.

What is claimed is:

1. A concrete 3D printing apparatus for buildings and structures, wherein the concrete 3D printing apparatus comprises:
a primary manoeuvering arm adapted to move rotationally along the horizontal plane;
a support base which is connected to a first end of the primary manoeuvering arm with a first drive mechanism in-between to actuate the movement of the primary manoeuvering arm;
a secondary manoeuvering arm adapted to move rotationally along the horizontal plane and attached to the second end of the primary manoeuvering arm with a second drive mechanism in-between to actuate the movement of the secondary manoeuvering arm; and
a linear translator setup at a distal end of the secondary manoeuvering arm, with a holding provision adapted to support a construction tool;
wherein the support base is configured to support the weight of the concrete 3D printing apparatus;
and
stabilisation mechanisms and load balancing for the stable movement of manoeuvring arms and frame and supporting the gravity load on the manoeuvring arms both at rest and during operation.

2. The concrete 3D printing apparatus as claimed in claim 1, wherein
the linear translator setup comprises a frame, a motor, a linear translation mechanism and a holding provision;
the holding provision is attached to bottom of the frame of the linear translator;
two parallel rods of the frame are movably attached to a mounting plate at the distal end of the secondary manoeuvring arm;
the linear translation mechanism is housed on the frame and is partially coupled to the mounting plate by mechanical means;
the motor drives the linear translation mechanism whereby the frame is actuated to move along the vertical plane to span the vertical range of the concrete 3D printing apparatus; wherein
the linear translation mechanism is either of a chain and sprocket, rack and pinion, and lead screw setup.

3. The concrete 3D printing apparatus as claimed in claim 1, wherein the frame is a nested frame comprising
a set of sub-frames with progressively decreasing width, nested within one another, wherein one sub-frame is slidably housed within the gap of the sub-frame with next higher width;
the sub-frames are configured to slide out to form an elongated structure;
the holding provision is attached to the bottom of the innermost sub-frame with the least width;
the outermost sub-frame is movably coupled to the mounting plate and is actuated to move vertically by the linear translation mechanism housed on it;
the other set of sub-frames are moved independent of the linear translation mechanism; and
the maximum vertical span of the holding provision is the length of the frame in the fully extended configuration.

4. The concrete 3D printing apparatus as claimed in claim 1, wherein the holding provision is adapted to support a construction tool; wherein the construction tool is a printhead connected to a hose nozzle for concrete 3D printing, wherein
the holding provision is configured to rotate the construction tool in 360 degrees.

5. The concrete 3D printing apparatus as claimed in claim 1, wherein
the support base is a hydraulic system oriented vertically, resting on an outer triangular base, comprising at least two sets of hydraulic cylinders;
wherein
each set comprises a plurality of hydraulic cylinders;
the vertical orientation of the hydraulic cylinders of one set is in the direction opposite to vertical orientation of the hydraulic cylinders of the other set; and
actuating of the hydraulic system is performed by sequential actuation of each set;
and on full actuation, the pistons of each set are extended in opposite direction.

6. The concrete 3D printing apparatus as claimed in claim 5, wherein the layered hydraulic system comprises:
three base hydraulic cylinders positioned at the vertices of the outer triangular base;
an inner triangular base attached to the outer cylinder of the three base hydraulic cylinders;
three top hydraulic cylinders positioned at the vertices of the inner triangular base;
an inner triangular top attached to the pistons of the three top hydraulic cylinders;
an outer triangular top attached to the top of the outer cylinder of the three base hydraulic cylinders;
wherein
the inner triangular top supports the first drive mechanism attached to the first end of the primary manoeuvering arm;
the outer cylinder of the three base hydraulic cylinders are movable with fixed pistons; and
the pistons of the three top hydraulic cylinders are movable with fixed outer cylinder.

7. The concrete 3D printing apparatus as claimed in claim 1, wherein the counter weight structure is another set of manoeuvering arms positioned diagonally opposite to the primary manoeuvering arm.

8. The concrete 3D printing apparatus as claimed in claim 1, wherein the first drive mechanism and second drive mechanism are slew drive mechanisms operated by a motor, wherein
the motor is a servo motor controlled by a closed loop control system; and
the effective gear ratio of the slew drive mechanism is above 40.

9. The concrete 3D printing apparatus as claimed in claim 1, wherein a secondary stabilisation mechanism supported on the secondary arm is provided for the stable movement of frame of the linear translator.

10. The concrete 3D printing apparatus as claimed in claim 1, wherein a tension support mechanism augments the load bearing of the primary and secondary manoeuvring arms.

11. The concrete 3D printing apparatus as claimed in claim 9, wherein the secondary stabilisation mechanism is a set of pulleys fixed on both sides of the secondary arm, with a set of tension cables running over the pulleys;
the ends of the tension cables are attached to the top and bottom of the metal frame of the linear translator, respectively; and
when the metal frame moves up and down, the vertical movement of the printhead is stabilized by the arrangement of tension cables supported on the pulleys.

12. The concrete 3D printing apparatus as claimed in claim 9, wherein the secondary stabilisation mechanism is a set of support shafts connected at one end to the bottom of the metal frame via pivot joints;
the other end of the support shafts is connected to a movable frame supported on guiding rails attached to both side of the secondary arm;
the movable frame is fixed on a lead screw connected to a lead screw motor at the one end and to the metal frame of the mounting plate at the other end;
the motor driving the linear translation mechanism is synchronized with the lead screw motor driving the lead screw; wherein
when the frame moves vertically upwards, the movable frame moves away the mounting plate; and when the frame moves vertically downwards then the movable frame moves towards the mounting plate.

13. The concrete 3D printing apparatus as claimed in claim 9, wherein the secondary stabilisation mechanism is a two-pulley belt stabilization means comprising a first pulley attached to top end of the linear translator and a second pulley attached at the top end of the connection position of the primary and secondary arm; and a belt over the two pulleys tensile support to stabilise the linear translator.

14. The concrete 3D printing apparatus as claimed in claim 10, wherein the tension support mechanism comprises
two cable supports installed along with dual rotating mechanisms, mounted on the elbow joint and on the far end of the primary arm;
turn buckles to facilitate movement of the cable support; wherein
first cable is connected to the printhead at one end and to the rotating mechanism on the elbow joint at the other end and the first cable comprises a turn buckle in between two sub unit cables;
second cable is connected to the rotating mechanism on the elbow joint at one end and to the rotating mechanism on the far end of the primary arm at the far end of the primary arm, and the second cable comprises a turn buckle in between two sub unit cables;
the truss support is also provided on the primary arm to further provide support to the arm.

15. The concrete 3D printing apparatus as claimed in claim 1, comprises light weight primary and secondary arm with truss structure; and the base support is a modular truss structure.
